(19) United States
(12) Patent Application Publication
(10) Pub. No.: US 2018/0007879 A1
(43) Pub. Date: Jan. 11, 2018

(54) MULTI-SENSORY FISH ATTRACTANT

(71) Applicant: BAITCLOUD INC., Oakville (CA)

(72) Inventors: Cheryl HOPKINS, Oakville (CA); Carl John RUDNIK, Mississauga (CA)

(21) Appl. No.: 15/645,588

(22) Filed: Jul. 10, 2017

Related U.S. Application Data
(60) Provisional application No. 62/360,090, filed on Jul. 8, 2016.

(51) Int. Cl. A01K 97/02; A01K 85/01

(52) U.S. Cl. CPC A01K 97/02; A01K 85/01

(57) ABSTRACT

Disclosed herein is a multi-sensory fish attractant. The attractant comprises an effervescent component that generates gas by a chemical reaction on contact with water, a glitter component, and further a binding component, such that the effervescent component and glitter components are combined in a mixture and maintained as a single mass until dissolved in water. The disclosed attractant is particularly devoid of any berley, chum, live or prepared bait components. Preferably the attractant is not directly attached to a fishing line or tackle. The glitter component is generally released with the effervescent component when the mixture is dissolved, creating an “attractant zone” to lure fish within proximity of an angler's hooked lure or bait.

### FIELD

The present disclosure relates to a multi-sensory fish attractant for sport fishing, which appeals to the visual, auditory, olfactory, taste and lateral line senses of fish, while being devoid of any berley, chum, live or prepared bait components.

### BACKGROUND

Fish are finely tuned to their senses, and to specific detectable patterns observed when locating their prey. Over time fish have evolved to follow these patterns closely, and in simulating such conditions their behavior can be controlled; thereby attracting fish to a target area.

Aquatic vertebrate fish possess a lateral line system, comprising sense organs that detect movement and vibrations in the surrounding water. The lateral line system is enabled by the modified epithelial cells on fish, which respond to motion induced displacement, and transduce received signals into electrical impulses to alert the fish of nearby motion. For example, a school of baitfish swimming in a feeding frenzy would create a small vortex, detectable by the lateral line system, and attract predator fish to the area. Such fish are further drawn towards the sight, sound, smell and the taste of a school of baitfish, and seek out similar sensory cues when they are in search of prey.

In the prior art, fish attractants that target these sensory cues in various embodiments have been disclosed.

For example, Bethshears et al. (U.S. Pat. No. 5,415,862) discloses a liquid fish attractant compound, designed for use as a coating to enhance the appeal of artificial lures and live baits. While the compound disclosed by Bethshears et al. targets all five sensory pathways in fish, their compound is immiscible with water, and is further limited to applications as a coating on a lure or bait. This constrains the volume of affected water that is able to attract fish, restricts the motion of the compound to that of the fishing line, and further limits the amount of effervescence given it must be coated on to bait of a defined surface area.

Watkins, Jr. (U.S. Pat. No. 5,201,138) discloses a malleable bubbling fish attractor, designed to appeal to visual sensory pathways in fish as an effervescing attachment apparatus speared to a lure. This compound is not soluble in water, and leaves behind waste wax material after the effervescing compound has been depleted. Further, it confines the visual stimuli to a small volume of water above the apparatus, is limited to motion with the fishing line, and appeals to only one of the five potential sensory pathways to attract fish.

Deluca (WO200158256A1) further discloses a fish attractant compound of a single mass designed to effervesce when thrown in water. This compound employs techniques to appeal to all five senses. The compound includes a “berley” component to act as a fish attractant, and explicitly aims to design a berley inclusive attractant compound of neutral odor. Further, the compound disclosed by Deluca is not entirely soluble, comprising sequins in its effervescent component, which presents a potential environmental challenge.

Galic (WO2014108710A1) similarly discloses an “effervescent briquette” of food for fish, which is afflicted by the same limitation as Deluca.

Therefore, it would be desirable to have a multi-sensory fish attractant compound that employs advanced biomimicry to leverage multiple forms of sensory attraction in fish, without the use of berley, chum, live or prepared bait to encourage target fish to be receptive to bait in the attractant zone.

### SUMMARY

The present application discloses a multi-sensory fish attractant, comprising: an effervescent component which generates gas through a chemical reaction on contact with water, a glitter component, a binding component such that the effervescent component and glitter components are combined in a mixture and maintained as a single mass until dissolved in water. The attractant releases the effervescent and glitter components when the mixture is dissolved. The attractant is devoid of any berley, chum, live or prepared bait components, and is not directly attached to the fishing line or tackle.

In an embodiment, the effervescent component is comprised of an acidic agent and an alkali being one of a metal carbonate, a bicarbonate, a hydrogen carbonate salt, or a combination thereof.

In another embodiment, such an alkali is one of a naturally occurring nahcolite, a chemically synthesized sodium bicarbonate, or a combination thereof. Additionally that the acidic agent may be citric acid or succinic acid.

The binding component may be comprised of oils, amino acids, food colouring, and pheromones, such that these components possess fish attractant properties.

In another embodiment, the attractant may include a bioluminescent component.

The effervescent and binding components as described may react in a stoichiometric ratio. An exemplary ratio is 2 units alkali to 1 unit acid agent. The colour may be 0.01 to 0.5 units and preferably 0.04 units. The oil may be 0.02 to 0.3 units and preferably 0.02 units. The glitter may be 0.01 to 0.02 units and preferably 0.01 units. The bioluminescent component may be 0.1 to 0.25 units.

The attractant may be a generally spherical shape and further the sphere may be approximately 1.6 Inches in diameter. The spherical shape may have a hole through an axis.

Alternatively, the attractant may be a generally tablet shape. The tablet shape may have a hole through an axis.

The attractant may have a hole through the center.

The attractant as described may be biodegradable, such that complete biodegradation occurs in fresh water and salt water at all liquid phase temperatures. The attractant may be soluble in fresh water and salt water at all liquid phase temperatures.

The attractant may be solid when dry.

In one embodiment the attractant is not directly attached to the fishing line or tackle.

The attractant may create an attraction zone when dissolved in water. The attraction zone may last a minimum of 30 minutes.

### BRIEF DESCRIPTION OF THE DRAWINGS

Embodiments disclosed herein will be more fully understood from the following detailed description thereof taken in connection with the accompanying drawings, which form a part of this application, and in which:

FIG. 1 shows a spherical embodiment of the multi-sensory fish attractant disclosed herein;

FIG. 2 shows an in situ image of the multi-sensory fish attractant shown in FIG. 1, including the attractant zone and an angler;

FIG. 3 shows a spherical embodiment similar to that shown in FIG. 1 but including a hole along an axis;

FIG. 4 shows a tablet shaped embodiment of the multi-sensory fish attractant disclosed herein; and

FIG. 5 shows a tablet shaped embodiment similar to that shown in FIG. 4 but including a hole along an axis.

### DETAILED DESCRIPTION

Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

As used herein, the terms “comprises” and “comprising” are to be construed as being inclusive and open ended, and not exclusive. Specifically, when used in the specification and claims, the terms “comprises” and “comprising” and variations thereof mean the specified features, steps or components are included. These terms are not to be interpreted to exclude the presence of other features, steps or components.

As used herein, the term “exemplary” means “serving as an example, Instance, or illustration,” and should not be construed as preferred or advantageous over other configurations disclosed herein.

As used herein, the terms “about” and “approximately” are meant to cover variations that may exist in the upper and lower limits of the ranges of values, such as variations in properties, parameters, and dimensions.

As used herein, the term “biodegradable” refers to a composition that decomposes into naturally occurring elements, is derived from sustainable sources, does not contain any genetically modified items, and is fully compostable.

As used herein, the term “soluble” references a material's ability to dissolve in water without leaving remnant precipitate.

As used herein, the term “berley” refers to bait that is scattered on water in order to attract fish. The berley is typically ground bait. The berleys vary a little, but as defined by Charles Thackery, in The Amateur Fisherman's Guide, 1895, the best ordinary berley is made out of bran, pollard, flour, salt or fresh herrings or tinned fish and bread crumbs.

As used herein, the term “chum” refers to chopped fish, fish fluids, and other material thrown overboard as angling bait.

As used herein, the term “live bait” refers to worms, small fish, crustaceans or other prey that are the natural food of sport fish.

As used herein the term “prepared bait” refers to any combination of edible components that may include ground fish parts, blood, and grains.

As used herein, the term “attractant zone” refers to the volume of water affected by the excretions of the disclosed compound when placed in a body of water.

### Ecology

Fish have evolved over time to become highly responsive to their senses, and to specific patterns detected when seeking out prey. There are five core sensory pathways that appeal to fish:

### 1. The Lateral Line System

Fish have a very sensitive apparatus (their lateral line system) through which they feel vibrations. The lateral line system is comprised of organs that detect movement and vibrations in the water surrounding a fish. It is enabled by the modified epithelial cells on the exterior of a fish, which respond to motion induced displacement, and transduce received signals into electrical impulses to alert the fish of nearby motion. Baitfish, when schooled together, are able to displace water, and create significant vibrations that predatory target fish are tuned to.

### 2. Auditory System

Fish are highly responsive to sounds through their otoliths, a sensitive structure within the inner ear, and further through their lateral line systems. As such, target predatory fish are often drawn to the noises generated by schools of baitfish.

### 3. Visual System

Fish possess both rod cells and cone cells in their visual systems (for both scotopic and photopic vision), and are further able to see clearly in colour. As such, target fish are highly sensitive to motion in the water, the shine of scales, and the release of bubbles, all of which are generated by schools of baitfish.

### 4. Olfactory (Scent) System

Fish further possess a sensitive scent apparatus, and can detect very minute concentrations of the chemicals in the water emitted by baitfish. All baitfish emit natural oils, and further emit specific amino acids and pheromones that our target species recognize.

### 5. Taste System

Similar to their olfactory senses, fish are able to use their sense of taste to identify the oils, flavours, amino acids and pheromones expected of their target prey.

The disclosed fish attractant employs advanced biomimicry techniques in the ingredients that target all five of these sensory dimensions in fish.

### Purpose of the Disclosed Multi-Sensory Attractant

The purpose of the disclosed multi-sensory fish attractant is to attract and retain target fish in a desired “attractant zone” for sport fishing. By closely mimicking the behaviour of baitfish across all five sensory dimensions (visual, auditory, olfactory, taste, and lateral line), a target predatory fish can be led to believe their prey are in the area.

Without any food (referred to as “berley” or “chum”) present in the attractant, the target predatory fish that have been attracted are more likely to strike at bait presented by the angler. Consequently, there is no berley or chum included in the attractant.

### Product Description

The multi-sensory fish attractant disclosed herein, comprises an effervescent component, a binding component, and a glitter component. The attractant employs advanced bio-mimicry techniques that target all five sensory dimensions in fish to completely impersonate a school of baitfish in a feeding frenzy, consequently attracting and retaining larger game fish to the area.

The effervescent component is comprised of an acidic agent, mixed with a carbonate compound, a metal carbonate, a bicarbonate, or hydrogen carbonate salt. This component undergoes a chemical reaction when exposed to water, and particularly targets the lateral line, visual, and auditory systems in target fish. This is achieved by releasing gas bubbles, vibrations, and noises that emulate a school of baitfish in the attractant zone.

The binding component serves the purpose of maintaining the attractant as a single mass, and is particularly devoid of any berley, chum or nutrient components, which entices target fish to take the angler's bait. Further, the binding component releases additional emulative ingredients detectable by the olfactory and taste systems, such as natural oils, amino adds, pheromones into the attractant zone.

The addition of berley or chum to a fish attractant is disadvantageous to the angler in practice, as it results in the establishment of multiple food sources in the attractant zone. Multiple food sources in the attractant zone distracts the fish, and interferes with its path to the bait; potentially to the extent that the target fish avoids the bait altogether.

Attracting target fish that avoid the intended bait is extremely undesirable in the context of sport fishing. This is a commercially significant consideration, given that individuals who partake in sport fishing annually spend approximately $42 billion USD on their activities, in the United States alone.

Further, in appealing to the taste and olfactory senses of fish, it has been shown that fish are more responsive to naturally occurring compounds, such as the mineral nahcolite or succinic acid, in place of chemically synthesized equivalents, e.g. sodium bicarbonate. In each piece of prior art previously disclosed, the effervescent component is comprised of a synthetic carbonate compound.

Finally, there is a glitter component, which is spread throughout the attractant zone in water, which appeals to fish visual senses in imitating the scales of a school of baitfish.

The fish attractant is intended to be thrown into the water beside a boat, to create an “attractant zone” surrounding the angler's fishing line, and bait. Further, the attractant can be used in any embodiment in fresh water or salt water due to its soluble and biodegradable properties, and is for year-round open and hard water fishing.

### Potential Product Embodiments

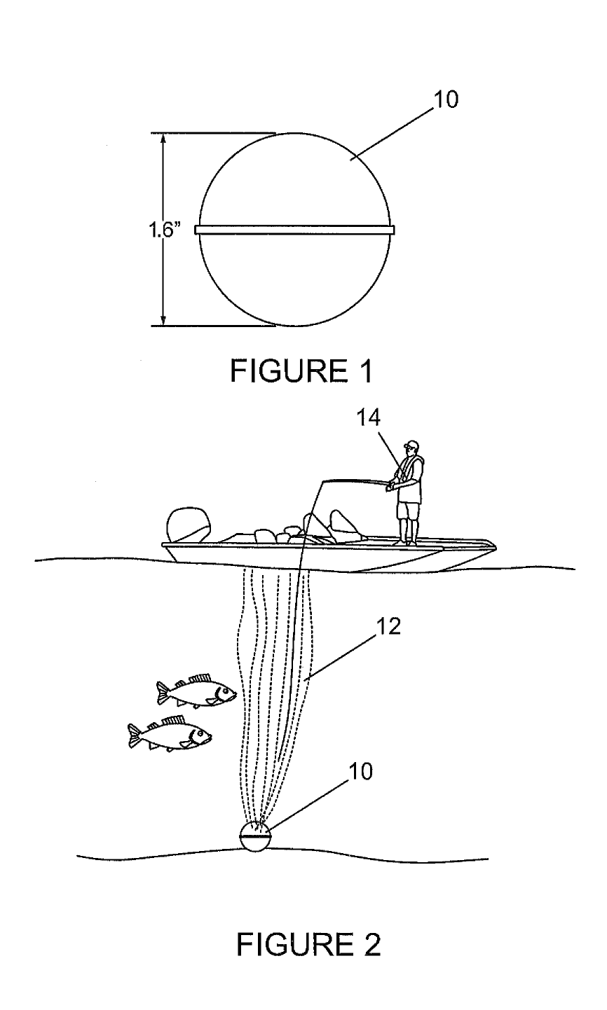

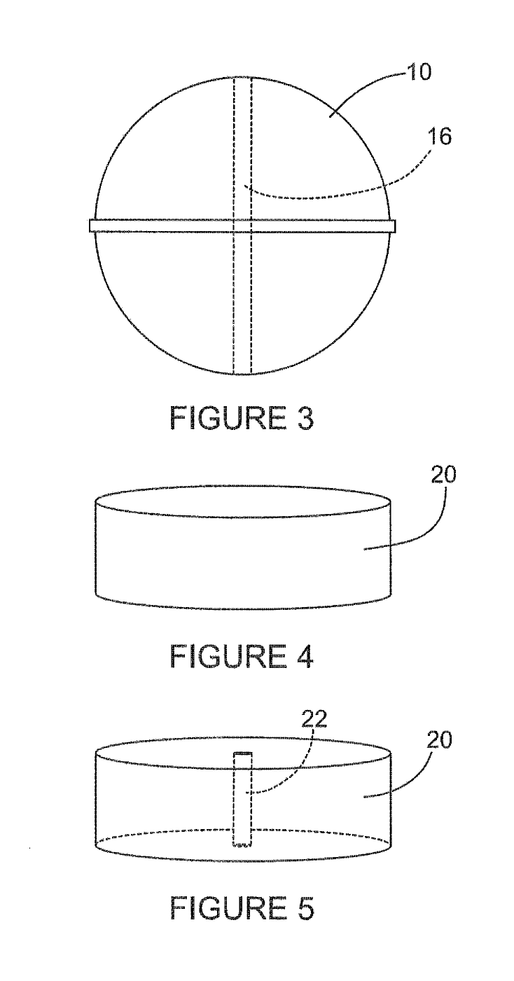

The disclosed attractant can be synthesized in a spherical embodiment, an exemplary model being one of 1.6 inches in diameter, as shown at 10 in FIG. 1. Such an embodiment can be dropped into water beside a fishing boat, and create an attractant zone 12 near the angler 14, as shown by FIG. 2. A spherical embodiment is preferable as it minimizes the surface area of the chemical reaction, maximizing the duration of the attractant effect.

It will be appreciated by those skilled in the art that a wide range of alternate sizes may be provided. As well, alternative shapes may be provided such as tablet shape shown in FIG. 4 at 20. The tablet shape 20 or the spherical shape may also be provided with a central hole 22 and 16 respectively down an axis. There are advantages and disadvantages of each alternative. For example, the basic sphere has the lowest surface area so the amount of time the effect lasts is increased. The tablet one the other hand is easier to manufacturing and to package since it is more stackable. A sphere with a small hole down the axis or tablet with a small hole down the centre axis allows an angler to attach the ball or tablet to a line for trolling or placement.

### Product Use

The disclosed multi-sensory fish attractant can be implemented by an angler with ease. Applicant, through diligent experiments, has obtained data describing the use of the multi-sensory fish attractant disclosed herein. By way of example the multi-sensory fish attractant in its spherical embodiment is 1.6 Inches in diameter, 45 grams in mass, and can be dropped or tossed into water to create the desired attractant zone. In 2 to 3 minutes, nearby target fish were observed to be drawn in around the angler's baited hook or lure—the only source of food in the attractant zone. In such a spherical embodiment the attractant were observed to create an attraction zone that lasts a minimum of 30 minutes. In this embodiment, the attractant is not attached in any way to the fishing line, the boat, or the angler.

It will be appreciated by those skilled in the art that the compaction may vary. By way of example only the compaction may range from 1.5:1 to 2.25:1. Thus the weight of a 1.6 inch diameter ball can vary between 50 g and 75 g.

### Composition

The Ingredients disclosed below are preferably arranged in a stoichiometric ratio. An exemplary model of such a preferred ratio being 2 units carbonate:1 unit acid agent:0.04 units colour:0.02 units organic oil:0.01 units glitter. More generally the carbonate and the acid are in a stoichiometric ratio and the remaining elements may be within a predetermined range. By way of example the carbonate and acid are in a 2:1 ratio. The colour may be 0.01 to 0.5 units; the oil 0.02 to 0.3 units; the glitter 0.01 to 0.02 units and the bioluminescent 0.1 to 0.25 units (if present).

Further, in a preferred embodiment, all of the attractant's primary ingredients are biodegradable, and soluble in water at all liquid phase temperatures.

### Effervescent Component

The effervescent component is generally comprised of an acidic agent with a metal carbonate, bicarbonate, or hydrogen carbonate salt. Such ingredients are non-reactive when dry, however undergo a chemical reaction in aqueous environments.

It is known that fish are more responsive to naturally occurring compounds than synthesized equivalents, and as such there is a preferred embodiment in which the carbonate is comprised of naturally occurring nahcolite.

In alternative embodiments the carbonate is synthesized sodium bicarbonate. Further, there is a preferred embodiment in which the acidic agent is citric acid or succinic acid. A bio-based succinic acid may be obtained from Bioamber™. Finally, there is a further preferred embodiment in which food colouring is added to the fish attractant.

### Glitter Component

The glitter particles of this component are preferably of about 1 mm in diameter. There is a further preferred embodiment in which the glitter component is comprised of “Bio-Glitter.” The biodegradable element of this exemplary glitter is derived from sustainable sources, does not contain genetically modified materials or materials obtained from genetically modified organisms.

### Bioluminescent Component

The bioluminescent ingredient is an optional component. The bioluminescent component is released when the effervescent component is dissolved in water. The bioluminescent component will serve to illuminate the attractant zone. By way of example only the bioluminescent component may be Lumoness™ from Biolume, Inc. a patented formulation that is the combination of a protein enzyme (Luciferase), a light emitting molecule (Luciferin), and oxygen. The protein enzyme catalyzes the reaction between the light-emitting molecule and oxygen to produce light. While there are many different luciferases found in nature, the luciferin is common among all bioluminescent sea creatures.

In one embodiment the luminescence is blue/green to stimulate a particular visual sensitivity in at least some fish. Scientific research shows that all members of this food chain have eyes sensitive to the colors blue and green. This may have evolved because the water these animals live in is blue or greenish in color. Water, containing little particulate matter, scatters light in the blue region of the spectrum. If water is rich in nutrients and contains photosynthetic microorganisms and plants, the chlorophyll in their bodies preferentially absorb red light. The remaining, unabsorbed light is transmitted and scattered, thus giving the water a greenish appearance. If water contains a lot of organic material from decaying plant life or suspended sediment, it may take on a yellow-brown color.

### Binding Component

The binding component is generally comprised of natural oils, salt, water, various amino adds, and various pheromones.

There is a preferred embodiment in which the natural oils are any of: fish oil, crayfish oil, corn oil, or garlic oil, or menhaden oil as different flavours are known to attract different species of fish.

### Production Method

The process for synthesizing the attractant is as follows: mix the dry ingredients (except the acid agent) using an Industrial mixer, add liquids and mix thoroughly, add oils/scents as necessary and mix for additional 20-60 seconds. This is referred to as the “Pre-Mix”.

When ready to mold, combine in the rotary mixer the Pre-Mix with citric acid to achieve the proper sodium bicarbonate to citric add ratio 2:1 and keep mixing for 60 seconds. The acid is only added when the Pre-Mix is thoroughly blended to avoid premature chemical reaction prior to molding.

The Pre-Mix is then poured into a hopper and fed into a mechanical press for molding using a 1.6 inch spherical mold. This is one embodiment of the product; however it may be alternatively offered in various sizes. In this embodiment, the mixture is pressed into spherical balls (shown by 10 in FIGS. 1 and 2) and dried for 24 hours before being handled for packaging.

In one embodiment of the product each mold contains a vertical post that creates a hole through the finished ball.

While the teachings described herein are in conjunction with various embodiments for illustrative purposes, it is not intended that these teachings be limited to such embodiments. On the contrary, the teachings described and illustrated herein encompass various alternatives, modifications, and equivalents, without departing from the embodiments, the general scope of which is defined in the appended claims.

Except to the extent necessary or inherent in the processes themselves, no particular order to steps or stages of methods or processes described in this disclosure is intended or implied. In many cases the order of process steps may be varied without changing the purpose, effect, or import of the methods described.

What is claimed is:

1. A multi-sensory fish attractant comprising:
an effervescent component which generates gas through a chemical reaction on contact with water;
a glitter component;
a binding component such that the effervescent component and glitter components are combined in a mixture and maintained as a single mass until dissolved in water;
wherein the glitter component is released with the effervescent component when the mixture is dissolved; and
wherein the attractant is devoid of any berley, chum, live bait or prepared bait components.

2. The multi-sensory fish attractant according to claim 1 wherein the effervescent component is comprised of an acidic agent and an alkali being one of a metal carbonate, a bicarbonate, a hydrogen carbonate salt or a combination thereof.

3. The multi-sensory fish attractant according to claim 2 wherein the alkali is one of a naturally occurring nahcolite, a chemically synthesized sodium bicarbonate and a combination thereof.

4. The multi-sensory fish attractant according to claim 2 wherein the acidic agent is one of citric acid and succinic acid.

5. The multi-sensory fish attractant according to claim 1 wherein the binding component includes oils, amino acids, food colouring, and pheromones.

6. The multi-sensory fish attractant according to claim 5 wherein the oils, amino adds, food colouring, and pheromones possess fish attractant properties.

7. The multi-sensory fish attractant according to claim 1 wherein the effervescent component and binding components react in a stoichiometric ratio.

8. The multi-sensory fish attractant according to claim 1 further including a bioluminescent component that is released when the effervescent component is dissolved in water.

9. The multi-sensory fish attractant according to claim 1 wherein the effervescent component is comprised of an acidic agent and an alkali being one of a metal carbonate, a bicarbonate, a hydrogen carbonate salt or a combination thereof, the binding component includes oils, amino acids, food colouring, and pheromones and the effervescent component and binding components react in a stoichiometric ratio being 2 units alkali to 1 unit acid agent.

10. A multi-sensory fish attractant according to claim 9 wherein the food colouring is 0.01 to 0.5 units.

11. A multi-sensory fish attractant according to claim 10 wherein the food colouring is 0.04 units.

12. A multi-sensory fish attractant according to claim 9 wherein the oils is 0.02 to 0.3 units.

13. A multi-sensory fish attractant according to claim 12 where in the oils is 0.02 units.

14. A multi-sensory fish attractant according to claim 9 wherein the glitter component is 0.01 to 0.02 units.

15. A multi-sensory fish attractant according to claim 14 wherein the glitter component is 0.01 units.

16. A multi-sensory fish attractant according to claim 9 further including a bioluminescent component.

17. A multi-sensory fish attractant according to claim 16 wherein the bioluminescent component is 0.1 to 0.25 units.

18. The multi-sensory fish attractant according to claim 1 has a generally spherical shape.

19. The multi-sensory fish attractant according to claim 1 has a hole through the center.

20. The multi-sensory fish attractant according to claim 18 wherein the spherical shape is approximately 1.6 Inches in diameter.

21. The multi-sensory fish attractant according to claim 1 a generally tablet shape.

22. The multi-sensory fish attractant according to claim 1 wherein the attractant undergoes complete biodegradation in fresh water and salt water.

23. The multi-sensory fish attractant according to claim 1 wherein the attractant is soluble in fresh water and salt water.

24. The multi-sensory fish attractant according to claim 1 wherein the attractant undergoes complete biodegradation in water of al liquid phase temperatures.

25. The multi-sensory fish attractant according to claim 1 wherein the attractant is soluble in water of all liquid phase temperatures.

26. The multi-sensory fish attractant according to claim 1 wherein the attractant is solid when dry.

27. The multi-sensory fish attractant according to claim 1 wherein the attractant is not directly attached to a fishing line or tackle.

28. The multi-sensory fish attractant according to claim 1 wherein the attractant creates an attraction zone when dissolved in water.

29. The multi-sensory fish attractant according to claim 28 wherein the attraction zone lasts a minimum of 30 minutes.

30. The multi-sensory fish attractant according to claim 5 wherein the oils are one of fish oil, crayfish oil, corn oil, garlic oil, and menhaden oil.
